(19) United States
(12) Patent Application Publication
(10) Pub. No.: US 2019/0075803 A1
(43) Pub. Date: Mar. 14, 2019

(54) WAFFLE AND BAKING MOLD FOR PRODUCING THE WAFFLE

(71) Applicant: Oexmann GmbH & Co. KG, Gelsenkirchhen (DE)

(72) Inventors: Thomas Oexmann, Gelsenkirchen (DE); Monika Oexmann, Gelsenkirchen (DE)

(21) Appl. No.: 16/124,457

(22) Filed: Sep. 7, 2018

(30) Foreign Application Priority Data
Sep. 13, 2017 (DE) DE102017121207.8

(51) Int. Cl. A21B 5/02; A21C 15/02

(52) U.S. Cl. CPC A21B 5/026; A23G 9/288; A21C 15/025

(57) ABSTRACT

A cone shaped waffle food product including a first side whose surface area is increased by a technical pattern in order to assure a defined adhesion at a baking plate during a production process and to provide engagement surfaces for a receiving tool, wherein the technical pattern includes bars or grooves that are respectively arranged parallel to each other; a second side whose surface area is smaller than the surface area of the first side, and wherein the second side is free from the technical pattern and provided with a design pattern.

### RELATED APPLICATIONS

This application claims priority from and incorporates by reference German patent application DE 10 2017 121 207.8 filed on Sep. 13, 2017

### FIELD OF THE INVENTION

The invention relates to shaped waffle with a cone shape forming a food product, the waffle comprising of a first side whose surface area is increased by a technical pattern in order to provide a defined adhesion at a baking plate during a manufacturing method and in order to provide engagement surfaces for a receiving tool, in particular with a pattern made from bars or grooves that are arranged parallel to one another, and with a second side whose surface area is smaller than the surface area of the first side.

### BACKGROUND OF THE INVENTION

Waffles of this type, in particular for receiving ice-cream are well known in the art. They typically have an outside with a diamond pattern. For this purpose the waffle is typically provided with bars that are arranged parallel to one another and intersecting bars are typically arranged at an angle of ninety degrees relative to each other.

The diamond pattern being a technical pattern is generated by the typical fabrication method for these waffles. During industrial fabrication waffle dough is applied to a first baking plate of a baking mold which includes an engraving that corresponds to the waffle bars. Thus, a surface of the waffle or of the lower baking plate of the baking mold is increased. The second baking plate which is applied to the first baking plate after the dough application in order to close the baking mold for baking does not have any engraving and is therefore flat. The larger surface area of the first baking plate generates a larger boundary surface area between the waffle and the baking plate. Therefore an adhesion of the baked waffle blade at the first baking plate that is provided with the engraving is greater than an adhesion at the second baking plate when the baking mold is opened. Therefore, it is assured that the baked waffle blade adheres at the first engraved baking plate.

A receiving tool is used for removing the baked waffle blade. Typically the receiving tool is an extraction blade with preceding prongs and knife edges arranged between the prongs. The prongs engage the engraving lines of the first baking plate and reach under the baked waffle dough that has penetrated into the engraving lines. This way the waffle blade is lifted which substantially improves the disengagement of the waffle blade and the reaching of the knife edges under the waffle blade.

It is appreciated that in this type of industrial waffle production the technical pattern of the waffle or the engraving of the baking plate has to exclusively satisfy the requirements of the baking process so that designing the outside of the waffle is only possible by selecting an offset of the engraving lines of the baking plate or of the bars formed by the waffle surface. Selecting the offset, however, has tight limits since the interaction of the receiving tongs and blade edges has to be assured when extracting the baked waffle blade from the engraved baking plate.

### BRIEF SUMMARY OF THE INVENTION

The invention relates to a baking mold for producing a waffle blade which is formable into a cone shaped waffle food product including a first side whose surface area is increased by a technical pattern in order to assure a defined adhesion at a baking plate during a production process and to provide engagement surfaces for a receiving tool, wherein the technical pattern includes bars or grooves that are respectively arranged parallel to each other; a second side whose surface area is smaller than the surface area of the first side, and wherein the second side is free from the technical pattern and provided with a design pattern.

Such baking molds for producing waffle blades that are rolled into cone shaped waffles are also well known in the art. They are being used in the industrial fabrication of waffles and include a first baking plate which is typically a lower baking plate whose baking side is provided with the technical engraving. This is typically an essentially diamond shaped pattern wherein the engraving lines forming the pattern are oriented parallel to each other and intersecting engraving lines typically have an intersection angle of 90 degrees.

The second baking plate has no engraving so that the surface area of the first baking plate is greater than the surface area of the second baking plate. Thus, adhesion forces at the first baking plate that is provided with the engraving are greater so that the baked waffle blade adheres to the lower baking plate that is provided with the engraving when the baking mold is opened.

After the baking process a receiving tool, typically an extraction blade engages the lower baking plate. The extraction blade includes preceding receiving prongs and blade edges arranged between the receiving prongs. The receiving prongs engage engraving lines and lift the baked waffle blade so that the blade edges in the remaining portions can move under the waffle blade easily.

Thus, the engraving of the lower baking plate is exclusively caused by technical parameters and does not allow any freedom of design. Only the offset between the engraving lines is adjustable to some extent. However, there are tight limits to the freedom so that the interaction between the preceding extraction prongs that lift the waffle blade and the blade edges that are arranged there between functions without flaws.

Thus, it is an object of the invention to provide a waffle whose visible exterior surface facilitates an individualized design.

This object is achieved by a cone shaped waffle food product recited supra whose second side that does not have the technical pattern is provided with a design pattern.

The inventors have found that the function of the technical pattern of the waffle is crucial to the industrial process so that the waffle side with the technical pattern does not allow any design freedom. A design, however, can be easily provided on the side that did not have the engraving so far as long as the surface area of the second side is smaller than the surface area of the first side that is provided with the technical pattern. An individual design of this second side facilitates giving the waffle a pattern that differs from the prior art which can be used to individualize the waffle and thus differentiate it over the competition. The inventors have furthermore found that it is possible to form this individually configured second side of the waffle as an outside so that the first side forms the inside of the waffle and the technical pattern is arranged on the inner-surface of the waffle.

It is further appreciated that the pattern to be created is arrangeable at will on the second side. Therefore, the entire outer surface is available to apply individual patterns.

The patterns can be lettering or a manufacture's logo or other patterns. It is theoretically conceivable to apply customer specific patterns to the waffle or information regarding contents of the food products packaged in the waffle, e.g. ice cream.

The object is also achieved by a baking mold with the features of claim 5, in particular its characterizing features according to which the second baking plate is provided with a design engraving which provides the waffle blade with a design pattern.

Thus, it is provided in particular that the design engraving is part of a switch element which sits in a switch receiver of the second baking plate.

With respect to the option to provide the second baking plate with a design engraving and the advantages associated therewith respective statement have already been provided supra with respect to the waffle.

According to a particularly preferred embodiment the baking plate is provided with a switch receiver for a switch element that is provided with the design engraving so that different design engravings can be applied to the waffle in a cost-effective manner. The baking mold itself is essentially unaffected since only the switch element with the respective design engraving is switched out. This does not only reduce production and purchase costs of the baking mold itself, but also retro fit times for switching out the engraving are reduced compared to switching an entire baking mold.

### BRIEF DESCRIPTION OF THE DRAWINGS

Further advantages of the invention and a better comprehension of the invention can be derived from the subsequent description of an advantageous embodiment of the invention with reference to drawing figures, wherein:

FIG. 1 illustrates a lower baking plate of a baking mold according to the invention for producing a waffle;

FIG. 2 illustrates an upper baking plate of a baking mold according to the invention with a switch receiver for producing a waffle;

FIG. 3 illustrates a switch element with a design engraving for the switch receiver of the baking plate according to FIG. 2;

FIG. 4 illustrates the baking plate according to FIG. 2 with the switch element according to FIG. 3 in the switch receiver;

FIG. 5 illustrates the baking plate according to FIG. 1 with dough applied;

FIG. 6 illustrates a waffle plate according to the invention with design engraving;

FIG. 7 illustrates a prior art waffle;

FIG. 8 illustrates a waffle according to the invention with an external design surface.

### DETAILED DESCRIPTION OF THE INVENTION

In the drawing figures a waffle according of the invention is designated overall with the reference numeral 10.

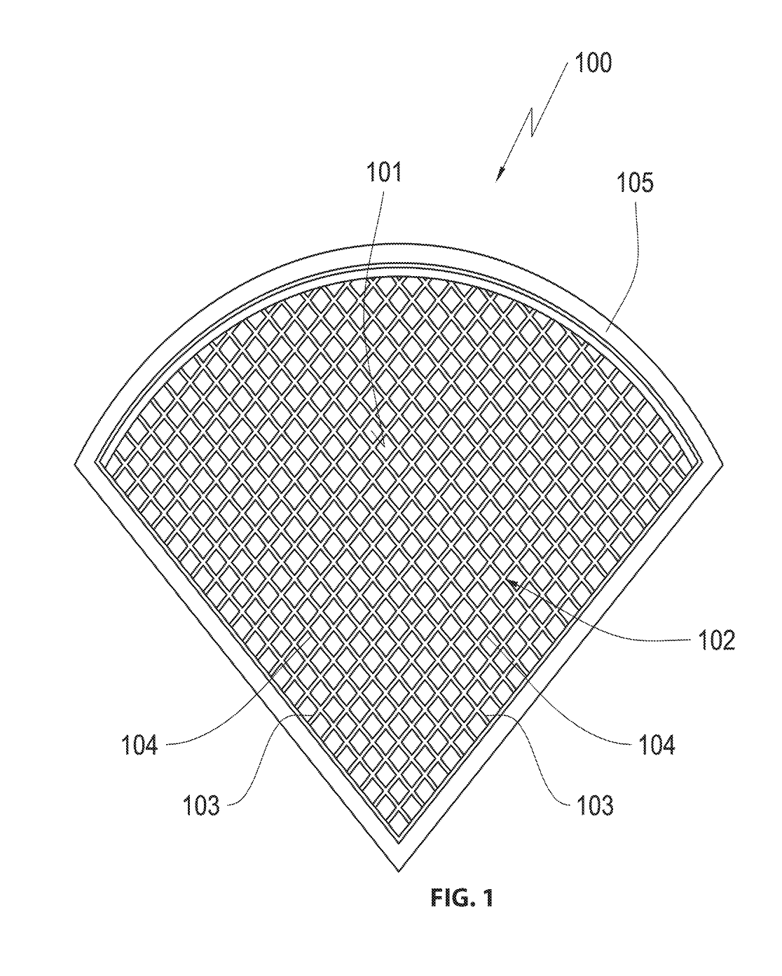

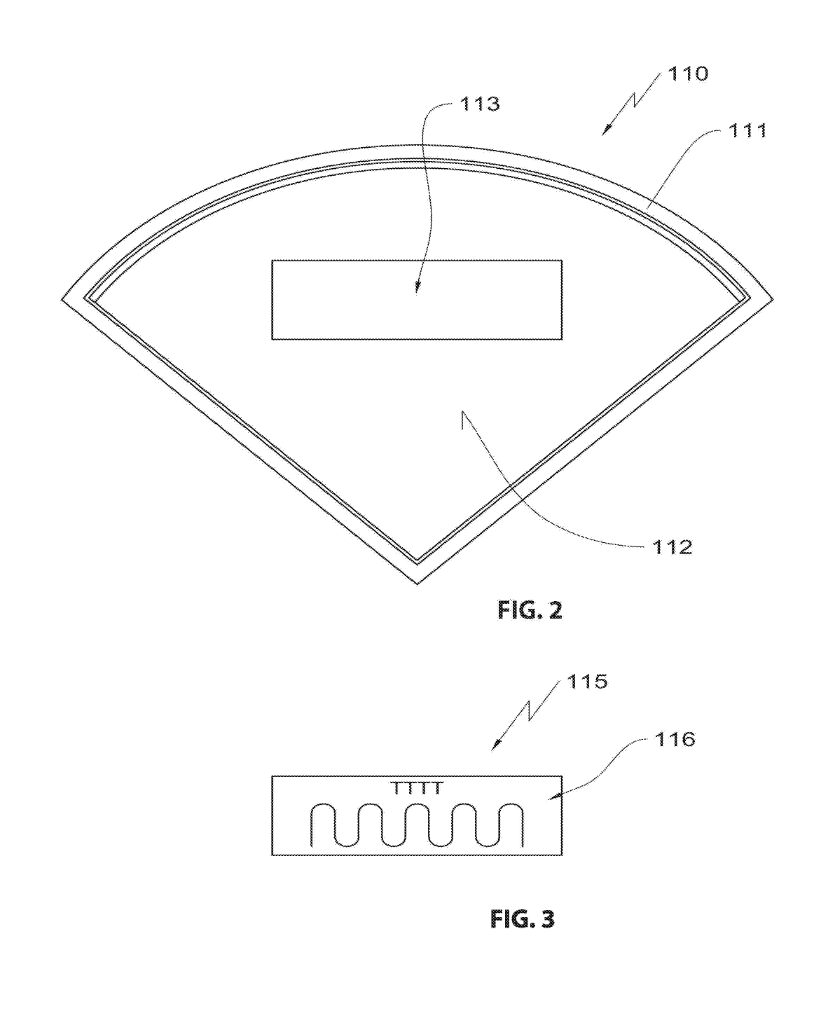

This waffle 10 according to the invention is produced by a baking mold which includes a lower baking plate 100 and an upper baking plate 110 which is illustrated in FIGS. 1 and 2.

The lower baking plate 100 has a baking surface 101. The lower baking plate 100 is provided with an engraving 102 that is formed by the engraving lines 103 and 104.

The engraving lines 103 are arranged parallel to each other. The engraving line 104 are arranged parallel to each other.

The engraving lines 103 intersect the engraving lines 104 at a right angle which yields a technical pattern which is essentially diamond shaped.

The lower baking plate 100 has a first terminal edge with the reference numeral 105 where the applied dough stops when the baking mold is closed.

FIG. 2 illustrates an upper baking plate 110 of the baking mold according to the invention. The upper baking plate 110 has a second terminal edge 111 where the applied dough stops when the baking mold is closed.

The baking surface 112 of the upper baking plate 110 is configured substantially flat and contrary to the upper baking plate 100 free from a technical pattern.

The upper baking plate 110 has a recess 113 which is part of a switch receiver that is not illustrated in more detail. A switch element 115 is inserted in a form locking manner into the switch receiver so that the recess 113 is closed when the switch element 115 is inserted.

FIG. 3 illustrates the switch element 115. The surface of the switch element 115 is provided with a design engraving 116.

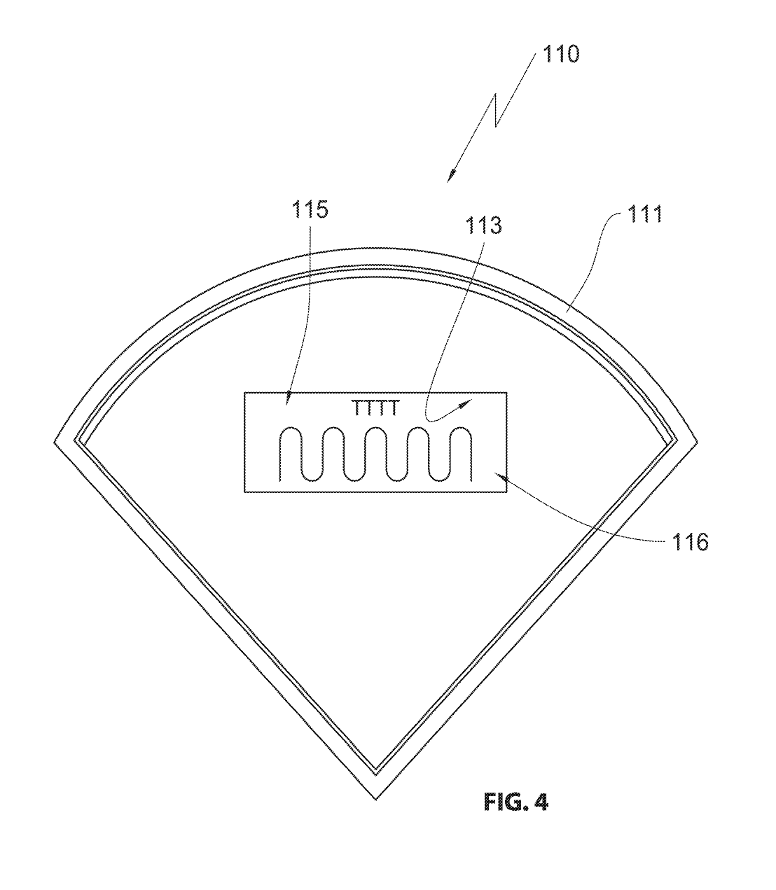

FIG. 4 illustrates the upper baking plate 110 according to FIG. 2 with the inserted switch element 115. The switch element 115 sits in the recess 113. The surface of the design engraving 116 of the switch element 115 is oriented towards the lower baking plate 100.

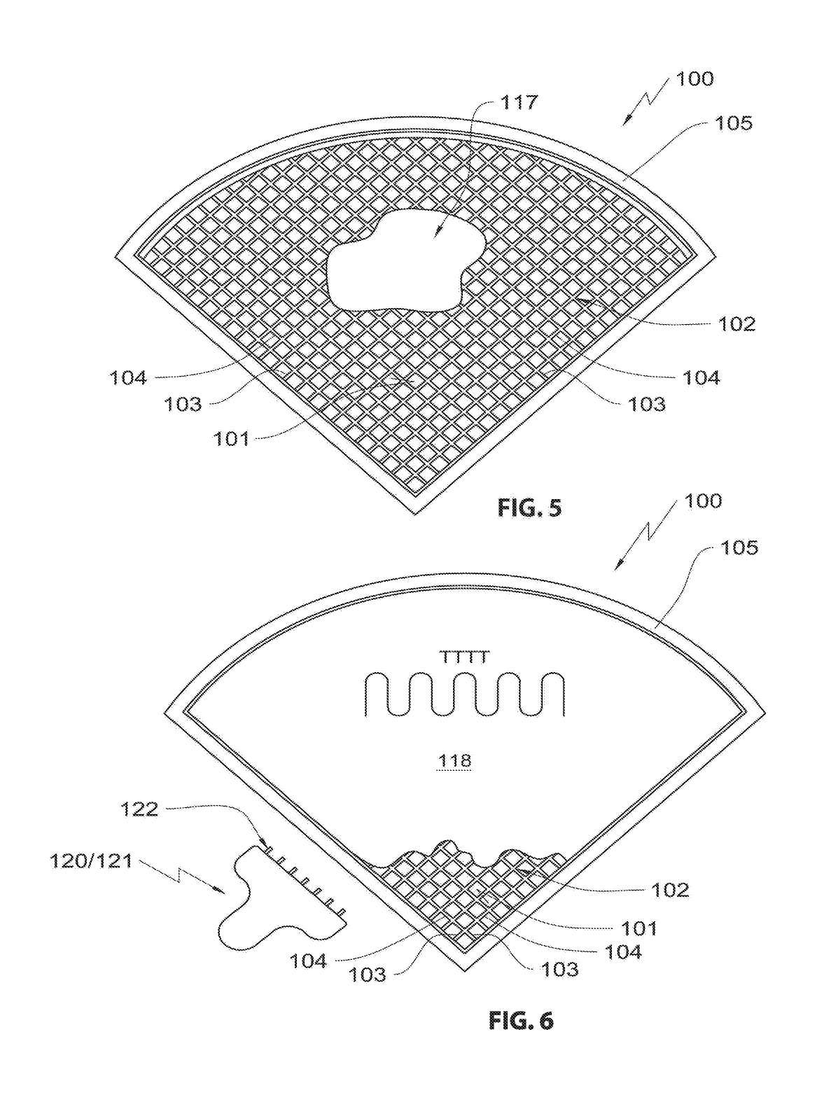

FIG. 5 illustrates the lower baking plate 100 according to FIG. 1 onto which a dough mass 117 is applied. The dough mass 117 is evenly distributed between the lower baking plate 100 and the upper baking plate 110 when the baking mold is closed and baked into a waffle blade 118.

The baked waffle blade 118 is shown in FIG. 6. A design surface 119 of the waffle blade 118 that is oriented towards the upper baking plate 110 is illustrated which was provided with the design of the design engraving 116 of the switch element 115 during the baking process by applying the upper baking plate 110.

The second waffle blade side of the waffle blade 118 that was provided with the design of the design engraving 116 and which is configured free from technical patterns is subsequently designated as design side.

The first waffle blade side of the waffle blade 118 which is not illustrated in more detail is provided with the technical pattern and subsequently also designated as technical side.

Additionally, a receiving tool 120 is illustrated which is configured as an extraction blade 121. The extraction blade 121 includes so called receiving prongs 122 which engage the engraving lines 103, 104 of the lower baking plate 100. The receiving prongs reach under the baked waffle blade 118 and disengage it from the lower baking plate 100. This process is enhanced by non-illustrated blade edges of the extraction blade 121.

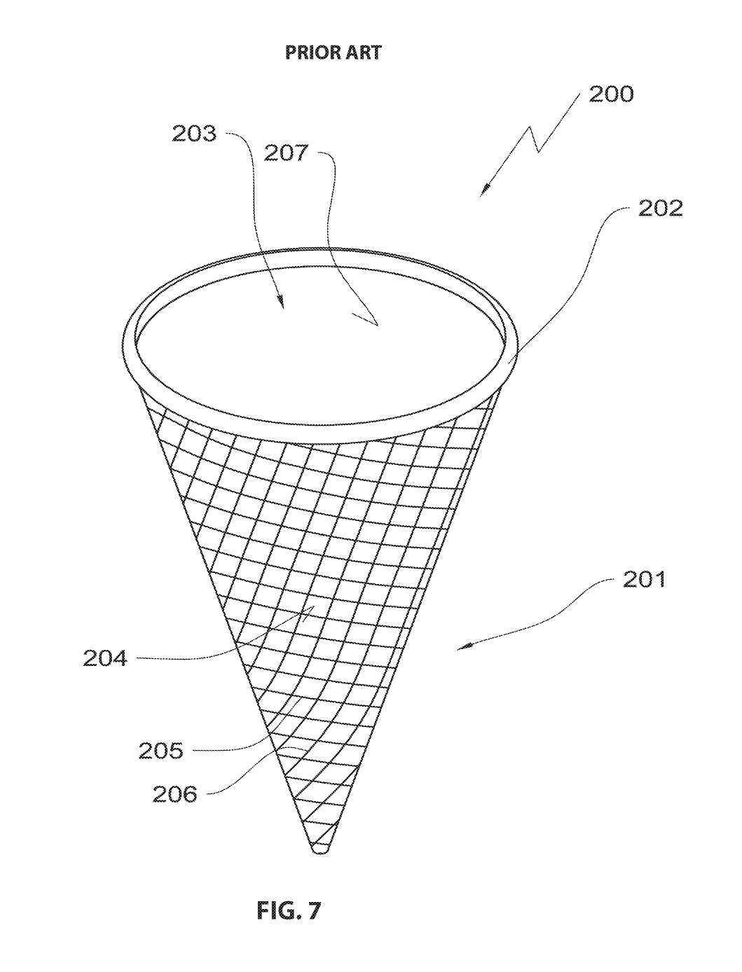

FIG. 7 illustrates a prior art ice cream waffle 200. This ice cream waffle is a first cone 201 that is rolled from a waffle blade wherein a first edge 202 of the first cone 201 defines a first waffle opening 203.

The outer surface 204 of the cone 201 is provided with bars 205 and 206 which are caused by the engraving 102 of the lower baking plate 100. According to the engraving lines 103, 104 the bars 205 and the bars 206 are respectively arranged parallel to each other and typically arranged at a right angle to each other in an intersection portion. The inner surface 207 of the first cone 201 is kept without engraving.

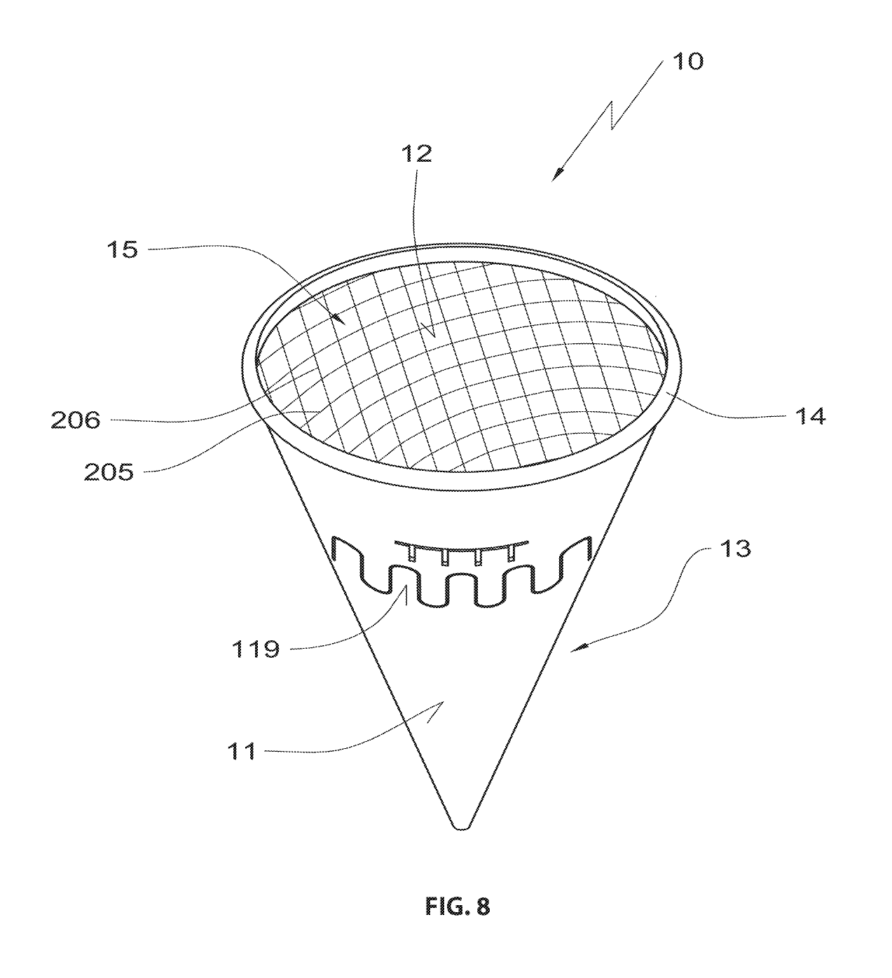

The waffle 10 according to the invention is illustrated in FIG. 8. This waffle 10 is a second cone 13 that is rolled up from a waffle blade 118 and whose edge 14 defines a second waffle opening 15.

The design surface 119 forms the outer surface 11 of the waffle 10 which is free from technical patterns. The design engraving 116 of the waffle blade 118 corresponds to the design engraving 116 illustrated in FIG. 4.

The inner surface 12 is provided with bars 205, 206 which are caused by the engraving 102 of the lower baking plate 100. The bars 205 and 206 are configured according to the engraving lines 103, 104. The intersecting bars 205 and 206 enclose a right angle in their intersection portion.

Producing the waffle 10 that is illustrated in FIG. 8 by a baking mold with a lower baking plate 100 and an upper baking plate 110 as described in FIG. 5 is performed as follows.

The dough mass 117 is applied to the lower baking plate 100 for the baking process. The upper baking plate 110 is applied to the lower baking plate 100. Thus, the dough mass 117 is evenly distributed and baked into a waffle blade 118.

Due to the technical engraving of the lower baking plate 100 receives a larger surface area compared to the upper baking plate 110.

Since the dough mass 117 penetrates the engraving lines 103 and 104 of the lower baking plate 100 when the upper baking plate 110 is applied the bars 205 and 206 form on the waffle side that is oriented towards the engraving lines 103, 104. Forming the bars 205 and 206 increases the surface area of this waffle side. Thus, retaining forces of the waffle blade 118 at the lower baking plate 100 are greater than at the upper baking plate 110. This way an adhesion of the waffle blade 118 at the lower baking plate 100 is assured.

Therefore, the waffle blade 118 disengages from the upper baking plate 110 when the baking mold is opened and adheres to the lower baking plate 100.

After the baking process the waffle blade 118 is separated from the lower baking plate 100 using the extraction blade 121 wherein the receiving prongs 122 engage the engraving lines 103, 104. The receiving prongs 122 reach under the baked waffle blade 118.

After disengaging the waffle blade 118 the waffle blade is rolled up in a winding machine with the technical pattern of the waffle blade on an inside to form a cone shaped waffle 10. Putting the technical pattern on the inside of the cone differs from the prior art.

Through the winding the design surface 119 becomes the outer surface 11 of the waffle 10 and the technical pattern with its bars 205, 206 is arranged on an inner surface 12 of the waffle 10.

The essential advantage of the waffle 10 according to the invention is the design freedom of the design surface 19. On the design surface 119 designs can be implemented free from technical constraints and thus allow an individual customer specific design.

The design pattern can be arranged on the waffle 10 at will wherein a design of any orientation, shape and size is conceivable and only limited by the surface area of the waffle cone 118.

Attention has to be paid that the surface area of the design surface 119 is smaller than the surface area of the side of the waffle blade 118 that is configured with the technical pattern in order to assure a defined disengagement when opening the baking mold.

The customer specific pattern can be any pattern, like e.g. the lettering or the logo of the manufacturer, information regarding contents of the food product packaged by the waffle, e.g. ice cream or the expiration date which improves differentiation over the competition.

When the upper baking plate 110 is provided with a switch receiver 114 different design options are possible on the design side of the waffle 10.

Through the configuration of the upper baking plate 110 with a switch receiver for a switch element 115 which is provided with the design engraving 116 different design engravings can be applied in a cost-effective manner on the design side of the waffle 10. The baking mold itself is not replaced since merely the switch element 115 with the respective design engraving 116 is replaced. This reduces production and purchase cost of the baking mold.

Furthermore, set up times for switching the engraving are reduced since only the upper baking plate 110 with the switch receiver 114 has to be replaced rather than replacing the entire baking mold.

### REFERENCE NUMERALS AND DESIGNATIONS

10 waffle

11 outer surface of 10

12 inner surface of 10

13 cone of 10

14 edge of 10

15 waffle opening of 10

100 lower baking plate

101 baking surface of 100

102 engraving

103 engraving line

104 engraving line

105 first terminal edge

110 upper baking plate

111 second terminal edge

112 baking surface of 110

113 recess

114 switch receiver

115 switch element

116 design engraving

117 dough mass

118 waffle blade

119 design surface

120 receiving tool

121 extraction blade

122 receiving prong

200 ice cream waffle

201 cone

202 edge of 200

203 waffle opening

204 outer surface of 201

205 bar

206 bar

207 inner surface of 201

What is claimed is:

1. A cone shaped waffle food product, comprising:
a first side whose surface area is increased by a technical pattern in order to assure a defined adhesion at a baking plate during a production process and to provide engagement surfaces for a receiving tool,
wherein the cone shaped waffle food product is rolled up from a waffle blade formed from a waffle dough and configured to receive ice cream,
wherein the technical pattern includes bars or grooves that are respectively arranged parallel to each other;
a second side whose surface area is smaller than the surface area of the first side,
wherein the second side is free from the technical pattern and provided with a design pattern, and
wherein the design pattern is formed by the waffle dough.

2. The cone shaped waffle food product according to claim 1, wherein the first side forms an inside of the cone shaped waffle food product and the technical pattern is arranged on the inside of the cone shaped waffle food product.

3. The cone shaped waffle food product according to claim 1, wherein the second side forms an outside of the cone shaped waffle food product and the design pattern is arranged on the outside.

4. The waffle cone shaped waffle food product according to claim 1, wherein the design pattern is freely arrangeable on the second side.

5. A baking mold for producing a waffle blade which is formable into the cone shaped waffle food product according to claim 1, the baking mold comprising:
a first baking plate whose baking side is provided with a technical engraving which increases a surface area of a waffle blade in order to assure an adhesion at the first baking plate,
a second baking plate whose baking side has a surface area that is smaller than a surface area of the first baking plate,
wherein the second baking plate is provided with a design engraving which provides the waffle blade with the design pattern.

6. The baking mold according to 5, wherein the design engraving is part of a switch element which sits in a switch receiver of the second baking plate.
